(19) United States
(12) Patent Application Publication
(10) Pub. No.: US 2006/0244282 A1
(43) Pub. Date: Nov. 2, 2006

(54) Vehicle with a tail gate

(76) Inventors: Dominique Benoit, Saint-Jean-Le-Blanc (FR); Fabien Dufour, Chateauneuf-Sur-Loire (FR); Dan Zanian, Paris (FR)

Correspondence Address: CARLSON, GASKEY & OLDS, P.C., 400 WEST MAPLE ROAD, SUITE 350, BIRMINGHAM, MI, 48009, US

(21) Appl. No.: 11/412,706

(22) Filed: Apr. 27, 2006

(30) Foreign Application Priority Data
Apr. 28, 2005 (FR) 05 04 288

(51) Int. Cl. B62D 33/00

(52) U.S. Cl. 296/50

(57) ABSTRACT

The invention relates to a vehicle including a body and a tail gate mobile in rotation relative to the body between a closed position and an open position. The vehicle also includes a gas spring for actuating the tail gate, where actuation of the tail gate by the gas spring is done by a first lever arm. The vehicle includes a transmission lever for actuating the tail gate and actuation of the tail gate by the transmission lever is done by a second lever arm greater than the first lever arm. The gas spring is adapted to activate the transmission lever. The tail gate can thus be opened more easily, while limiting the bulk of the drive mechanism of the tail gate.

### REFERENCE TO RELATED APPLICATION

This application claims priority to French Patent Application FR 05 04 288 filed on Apr. 28, 2005.

### BACKGROUND OF THE INVENTION

The present invention relates to a vehicle with a tail gate.

A vehicle tail gate is traditionally hinged to a rear of a body of a vehicle, and activating the tail gate can be realized by gas springs. FIG. 1 shows the embodiment of such a tail gate according to the prior art. A vehicle includes a body 12 and a tail gate 14 situated to a rear of the body 12, the tail gate 14 being moveable by a drive mechanism. The tail gate 14 is hinged to the body 12 about an axis of articulation, by a hinge 18. A gas spring 16 helps set the tail gate 14 in motion about the hinge 18. The gas spring 16 is connected to the body 12 by a hinge 20 and to the tail gate 14 by a hinge 22. In FIG. 1, various positions of the tail gate 14 are also shown, that is, a closed position 24, intermediate positions 26 and 27 and an open position 28 are shown.

In each of the illustrated positions 24, 26, 27 and 28 of the tail gate 14, the gas spring 16 is likely to exert torque on the tail gate 14 relative to the hinge 18 with a lever arm 30, 31, 32 and 34, respectively. It is to be noted that the lever arm 30 increases between the closed position 24 and the open position 28. In particular, the line of action of the gas spring 16 in the closed position 24 is close to the hinge 18. The lever arm 30 in the closed position 24 is therefore weak, and the gas spring 16 cannot alone tense the tail gate 14 to open it. The user must then impel the tail gate 14 into the intermediate position 26, where the gas spring 16 has a lever arm 31 strong enough to open the tail gate 14 itself. The intermediate position 26 corresponds to an automatic opening position of the tail gate 14 by the gas spring 16. Only the gas spring 16 impels the tail gate 14 in order to thrust it into the open position 28. In the open position 28 of the tail gate 14, the lever arm 34 of the gas spring 16 is such that the gas spring 16 can overcome the torque exerted by the weight of the tail gate 14 and tends to close the tail gate 14. In the open position 28, the tail gate 14 is kept open.

While the trunk is being closed, the user pushes the tail gate 14 into the intermediate position 27 with a lever arm 32, a position from which the weight of the trunk exerts torque relative to the hinge 18 greater than the torque exerted by the gas spring 16 relative to the hinge 18. The tail gate 14 closes alone from this position. This intermediate position 27 corresponds to an automatic closing position of the tail gate 14.

The drawback to this tail gate 14 during opening is that the user has to deploy considerable force to compensate for the weight of the tail gate 14 in order to open the tail gate 14 as far as the intermediate position 26. If the aim is to limit the force deployed by the user, this implies that the gas spring 16 must be oversized to succeed in opening the tail gate 14. The disadvantage here is the requirement to utilize a cumbersome drive mechanism. In addition, the disadvantage of an oversized gas spring 16 for opening is that the user is faced with difficulties in overcoming the effort of the gas spring 16 while the tail gate 14 is maneuvered for closing.

Another solution consists of augmenting the lever arm 34 of the gas spring 16 relative to the hinge of the tail gate 14 to the body 12. For this, the point of hinge of the gas spring 16 on the body 12 located in a gutter of the body 12 is pushed more inside the vehicle. This implies that the gutter is deeper. The drawback here is that the capacity of the trunk is compromised. The drive mechanism of the tail gate 14 is bulkier, and a size of the trunk in the vehicle is reduced. There is therefore a need for a drive mechanism which facilitates the movement of the tail gate 14 by being less bulky.

### SUMMARY OF THE INVENTION

The present invention proposes a vehicle including a body and a tail gate mobile in rotation relative to the body between a closed position and an open position. The vehicle includes a gas spring for actuating the tail gate, and actuation of the tail gate by the gas spring is done by a first lever arm. The vehicle includes a transmission lever for actuating the tail gate, and the actuation of the tail gate by the transmission lever is done by a second lever arm greater than the first lever arm. The gas spring is adapted to activate the transmission lever.

According to a variant of the invention, the second lever arm is greater than the first lever arm in the closed position of the tail gate. According to a variant, the transmission lever is adapted to actuate the tail gate between a first position and a second position. According to another variant, only the gas spring is adapted to actuate the tail gate beyond the second position. According to a variant, the first position of the tail gate is a closed position. According to another variant, the second position of the tail gate is an intermediate position between the closed position and an open position.

According to a variant, the transmission lever is in sliding contact with the tail gate. According to another variant, the gas spring has a degree of liberty in translation relative to the body. According to another variant, the vehicle further includes an intermediate component hinging the gas spring to the body. According to another variant, the intermediate component is the transmission lever.

According to a variant, the lever includes a main lever for actuating the tail gate and a second lever for hinging to the body. The main lever and the second lever rotate together between a first angular position and a second angular position of the tail gate. The main lever is adapted to be driven in rotation by the gas spring relative to the second lever beyond the second angular position of the tail gate. According to another variant, the main lever and the second lever are articulated elastically to one another. According to another variant, the gas spring is hinged on the second lever.

According to a variant, the body of the vehicle includes a gutter, and the transmission lever and the gas spring are in the gutter in the closed position of the tail gate.

According to a variant of the invention, the vehicle also includes a motor for activating the gas spring and an electronic control unit linked to the motor. The electronic unit is fitted with an anti-pinching function and/or an anti-collision function for the movements of the tail gate.

The invention also relates to a process for driving a tail gate relative to a vehicle body, such as described hereinabove. The method includes the steps of actuating the tail gate by the gas spring and by the transmission lever between two angular positions of the tail gate and actuating the tail gate only by the gas spring between two other angular positions of the tail gate.

### BRIEF DESCRIPTION OF THE DRAWINGS

Other characteristics and advantages of the invention will emerge from the following detailed description of the embodiments of the invention, given purely by way of example and in reference to the diagrams, in which:

FIG. 1 shows a tail gate with a drive mechanism according to the prior art;

FIG. 2 shows a tail gate and a drive mechanism according to an example of the invention;

FIG. 3 shows various positions of the tail gate of FIG. 2;

FIG. 4 shows a position of the tail gate of FIG. 2;

FIG. 5 shows a position of the tail gate of FIG. 2;

FIG. 6 shows a position of the tail gate of FIG. 2;

FIG. 7 shows a position of the tail gate of FIG. 2;

FIG. 8 shows a variant of the drive mechanism of the tail gate;

FIG. 9 shows a variant of the drive mechanism of the tail gate;

FIG. 10 shows a variant of the drive mechanism of the tail gate;

FIG. 11 shows a variant of the drive mechanism of the tail gate;

FIG. 12 shows a variant of the drive mechanism of the tail gate;

FIG. 13 shows a position of the tail gate of FIGS. 11 and 12;

FIG. 14 shows a position of the tail gate of FIGS. 11 and 12;

FIG. 15 shows a position of the tail gate of FIGS. 11 and 12; and

FIG. 16 shows a sectional view according to the line AA of FIG. 13.

### DETAILED DESCRIPTION OF THE INVENTION

The invention relates to a vehicle including a body and a tail gate mobile in rotation relative to the body between a closed position and an open position. A return gas spring and a lever actuates the tail gate in rotation with each lever arm. A lever arm of the transmission lever is greater than a lever arm of the gas spring. Also, the gas spring is adapted to activate the transmission lever. Accordingly, the tail gate is actuated not only by a first component which is the gas spring, but also by a second component which is the transmission lever, which increases the torque exerted the tail gate. Since the gas spring activating the transmission lever has a lever arm greater than the lever arm of the gas spring, there is accordingly transmission of the effort from the gas spring to the transmission lever and demultiplication of the lever arm actuating the tail gate. An increase in the opening torque of the tail gate is achieved, enabling easier opening of the tail gate. In parallel to this, the bulkiness of the drive mechanism of the tail gate is limited, and the effort needed to close the tail gate is similar to the effort deployed in a conventional tail gate.

Whether during opening or closing of the tail gate, the tail gate is driven by a drive process, according to which the tail gate is actuated by the transmission lever and the gas spring between two angular positions and is actuated by the gas spring alone between two other angular positions. In particular, the gas spring activates the transmission lever. Thus, on opening of the tail gate, the transmission lever actuates the tail gate between a first position and a second position, and beyond the second position, only the gas spring actuates the tail gate. The second position corresponds to an angular position of the tail gate (between the closed position and the open position) in which the opening of the tail gate is automatic. The first position corresponds to the closed position of the tail gate. On closing the tail gate, only the gas spring actuates the tail gate between a third position and a fourth position, and beyond a fourth position, the gas spring and the transmission lever actuate the tail gate. The fourth position corresponds to an angular position of the tail gate (between the open position and the closed position) in which closing of the tail gate is automatic. The third position corresponds to the open position of the tail gate. The process described facilitates the drive of the tail gate.

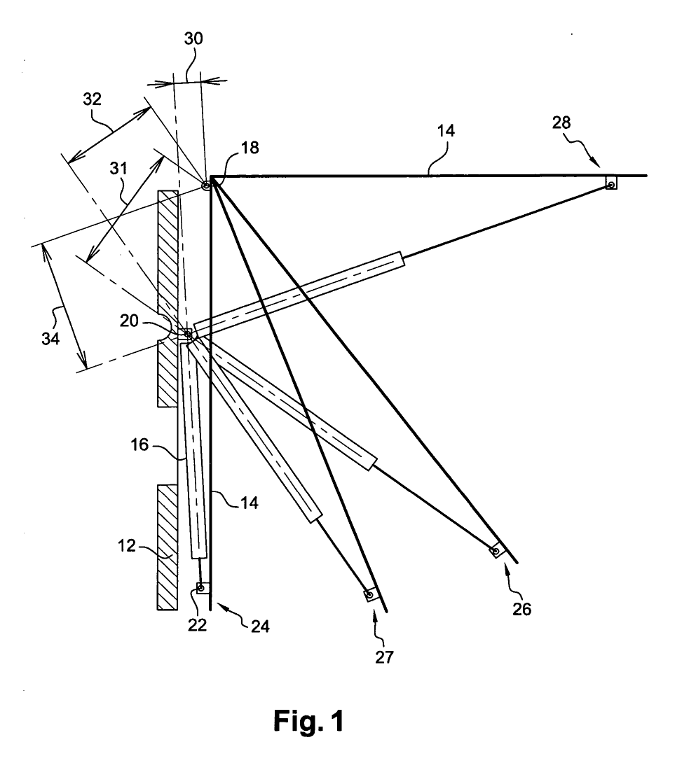

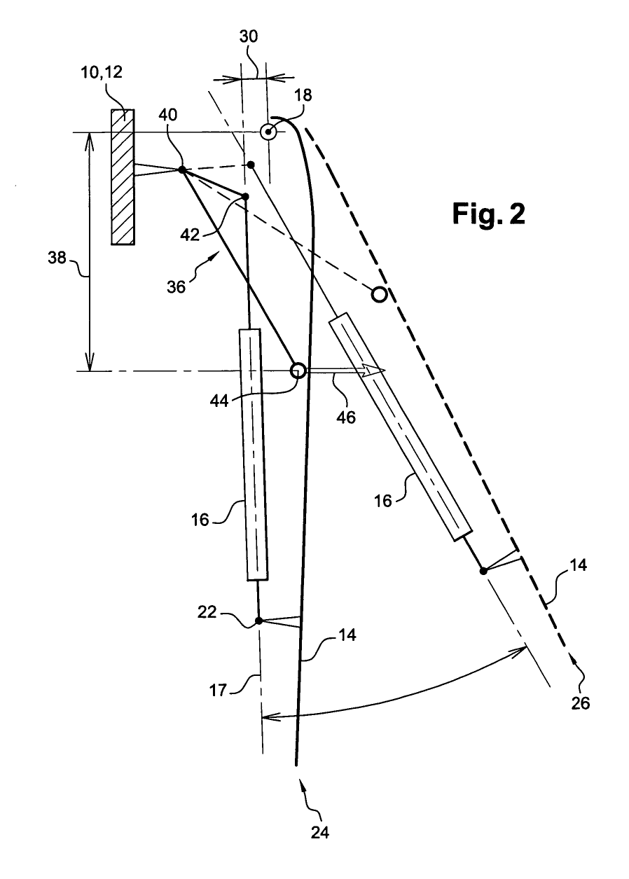

FIG. 2 shows a tail gate 14 according to an example of the invention. The elements of FIG. 1 represented in FIG. 2 are referenced in the same manner. Therefore, the vehicle 10 is shown schematically by the body 12. In particular, the rear of the body 12 is represented with the hinge 18 of the tail gate 14 on the body 12. The drive mechanism of the tail gate 14 includes the gas spring 16, also shown, with the hinge 22 on the tail gate 14. The line of action 17 of the gas spring 16 is visible. The distance between the line of action 17 and the hinge 18 is a lever arm 30 of the torque exerted by the gas spring 16 on the tail gate 14 about the hinge 18. The drive mechanism further includes a transmission lever 36. The transmission lever 36 actuates the tail gate 14, and the transmission lever 36 is itself actuated by the gas spring 16. The transmission lever 36 exerts a torque on the tail gate 14 with a lever arm 38. The lever arm 38 is greater than the lever arm 30. So, only by the action of the gas spring 16, not only is the tail gate 14 displaced by the torque of the gas spring 16, but also an additional torque is exerted by the transmission lever 36 on the tail gate 14.

The tail gate 14 is mobile between several angular positions, between a closed position 24 and an open position 28, the open position 28 being visible in FIG. 1. The closed position 24 corresponds to a position in which the tail gate 14 blocks the trunk of the vehicle. The open position 28 of the tail gate 14 is a position in which the tail gate 14 is immobilized in height and allows access to the trunk of the vehicle. FIG. 2 also shows an intermediate position 26. The intermediate position 26 corresponds to an automatic opening position of the tail gate 14. In the intermediate position 26, the gas spring 16 is capable of opening the tail gate 14 without the aid of the user.

The vehicle can include two gas springs 16 for actuating the tail gate 14. A gas spring 16 is mounted on either side the tail gate 14 according to a direction of advance of the vehicle. The presence of two gas springs 16 helps to stabilize the movement of the tail gate 14. Each gas spring 16 may be provided with the transmission lever 36 such that the movement of the tail gate 14 is all the easier as it is being stabilized.

The gas spring 16 can function in manual mode or in an automatic mode. In the manual mode, the gas spring 16 facilitates the opening maneuver of the tail gate 14 by the user, once the user has initiated opening of the tail gate 14. The gas spring 16 facilitates lifting of the tail gate 14. When the tail gate 14 has reached its open position, the gas spring 16 immobilizes the tail gate 14 in the open position and prevents it from an uncontrolled return to the closed position.

In the automatic mode, the gas spring 16 is activated by a motor. This helps manipulation of the tail gate 14 by the user, since the user no longer has to manipulate the opening of the tail gate 14 himself. For example, the user can initiate activation of the gas spring 16 by the motor using a remote control. The remote control sends a signal, initiating opening of the lock, which keeps the tail gate 14 in the closed position. Once the lock is open, the motor activates one of the gas springs 16, thus causing displacement of the tail gate 14 from the closed position to the open position. The motorized gas spring 16 functions, for example, with a motor driving a cable. The cable actuates in extension or in retraction a piston of the gas spring 16 relative to a chamber of the gas spring 16. Alternatively, the gas spring 16 can be composed of a bolt and nut system. For this, the piston of the gas spring 16 includes a threaded part cooperating with an internal screw thread of the internal wall of the chamber of the gas spring 16, such as a screw in a nut. The piston is driven in rotation, for example by a motor, a rotary cable and a cardan. The chamber of the gas spring 16, whereof the rotation is blocked, is then driven in translation, causing extension or retraction of the gas spring 16. The extension or retraction of the gas spring 16 is ensured by compressed gas. Finally, the manual mode can regain the upper hand in the event of a breakdown in an automatic mode.

The drive motor can be associated with an electronic control fitted with an anti-pinching function and/or an anti-collision function for the movements made by the tail gate 14. This function may include a classic algorithm consisting of measuring parameters of the motor, and in particular the current passing through the motor and the angular position of the rotor shaft of the motor. For example, when the current value, combined with a motor position, exceeds a predetermined threshold value, the electronic control interprets this as the presence of an obstacle in the course of the tail gate 14 and issues a stop command, even reversing the direction of rotation of the motor. This function can include a detection feature known from the prior art, such as sensitive joints in the periphery of the opening leaf, or optical contact less feature, or combinations of these features.

The transmission lever 36 is shown according to an embodiment in FIG. 2. According to this embodiment, the transmission lever 36 connects the gas spring 16 to the body 12. In particular, the transmission lever 36 hinges the gas spring 16 to the body 12. The gas spring 16 actuates the tail gate 14 by the transmission lever 36. More specifically, a hinge 40 connects the transmission lever 36 to the body 12, and a hinge 42 connects the transmission lever 36 to the gas spring 16. The gas spring 16 is not hinged directly to the body 12. The transmission lever 36 actuates the tail gate 14 by sliding contact 44.

To have the tail gate 14 move from a first angular position to a second angular position, corresponding respectively to the closed position 24 to the intermediate position 26 shown in FIG. 2, the transmission lever 36 exerts a force 46 against the tail gate 14. The lever arm 38 of the torque exerted by the transmission lever 36 about the hinge 18 is greater than the lever arm 30 of the torque exerted by the gas spring 16 alone in FIG. 1. Therefore, in the closed position of the tail gate 14, the developed lever arm is increased. This allows the force deployed by the gas spring 16 to be reduced. The gas spring 16 does therefore not need to be oversized, making it less expensive. In particular, in the case of a motorized gas spring 16, the motor utilized is less bulky and less heavy. In particular, a gear motor already used for driving a window regulator can be used. This makes the motor less expensive.

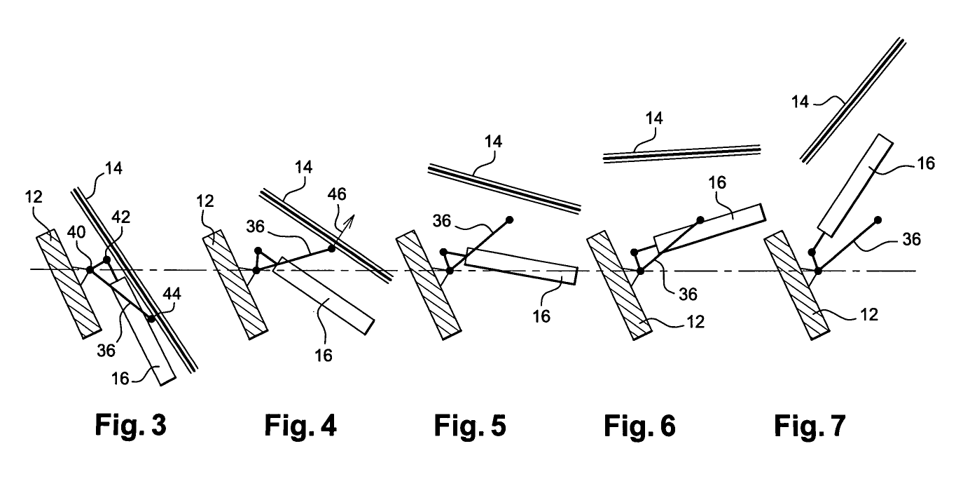

FIGS. 3 to 7 show the different steps of opening of the tail gate 14. The figures show the body 12, the gas spring 16, the transmission lever 36 and the tail gate 14. The gas spring 16 is hinged on the one side to the tail gate 14 (not visible) and on the other side to the transmission lever 36 by the hinge 42. The transmission lever 36 is hinged to the body 12 by the hinge 40 and is in contact with the tail gate 14 by way of the sliding contact 44. The tail gate 14 is hinged to the body 12 (not visible).

In FIG. 3, the tail gate 14 is in the closed position. When the tail gate 14 is activated to open according to FIG. 4, the gas spring 16 activates the transmission lever 36. The transmission lever 36 rocks around the hinge 40 on the body 12 and actuates the opening of the tail gate 14 according to the force 46. The tail gate 14 moves from the closed position to the intermediate position as per FIG. 4. During this movement, the transmission lever 36 and the gas spring 16 have developed an opening torque with a lever arm greater than a lever arm of the gas spring 16 that actuates the tail gate 14 alone.

In FIG. 4, the transmission lever 36 can abut in rotation. The actuating of the tail gate 14 by the transmission lever 36 is interrupted. The tail gate 14 is in the automatic opening position, and only the gas spring 16 actuates the tail gate 14 to open. Nevertheless, the transmission lever 36 has helped the opening of the tail gate 14 until this automatic opening position. The gas spring 16 has reached the intermediate position beyond which the torque exerted by the gas spring 16 on the tail gate 14 is created by a lever arm sufficiently strong to continue the opening of the tail gate 14, as shown in FIGS. 5 and 6. In these figures, only the gas spring 16 actuates the tail gate 14 to open. Since the gas spring 16 is hinged to the transmission lever 36, the gas spring 16 is driven in rotation relative to the transmission lever 36. Finally, the gas spring 16 actuates the tail gate 14 until the open position shown in FIG. 7. The gas spring 16 keeps the tail gate 14 in the open position.

When the gas spring 16 is in the automatic mode and activated by a motor, the transmission lever 36 activated by the gas spring 16 facilitates passage of the tail gate 14 between the automatic closing position and the opening position. The gas spring 16 and the transmission lever 36 actuate the tail gate 14 with a stronger lever arm, which helps to reduce the size of the motor. This makes the mechanism actuating the tail gate 14 less bulky and less expensive. When the gas spring 16 is in the manual mode and activated by the user, the effort to be provided by the user is less important to push the tail gate 14 until the automatic opening position.

To close the tail gate 14 from the position in FIG. 7 to the position in FIG. 3, the tail gate 14 is thrust downwards by the user or by the motor. The gas spring 16 brakes the closing of the tail gate 14 by actuating it upwards. The tail gate 14 is pushed into the intermediate position 27 of automatic closing in FIG. 1, in which the tail gate 14 is driven by its own weight only, the movement still being braked by the gas spring 16 which actuates the tail gate 14 in the opposite direction. When the tail gate 14 arrives at the position in FIG. 4, the transmission lever 36 again makes contact with the tail gate 14. The transmission lever 36 actuates the tail gate 14 in the opposite direction, which dampens the closing movement of the tail gate 14.

Tests on the effort to be provided to open the tail gate 14 by pushing on the gas spring 16 according to the lever arm 30 were conducted and are the following, for example. Without using the transmission lever 36, such as it is the case in FIG. 1, the lever arm 30 of the gas spring 16 in the closed position 24 is of the order of 10 mm, and the effort is 8000 N to open the tail gate 14. When the lever arm 30 is 30 mm, the effort is 2000 N (without using the transmission lever 36). By substantially keeping the lever arm 30 to 10 mm and by using the transmission lever 36, the effort is 800 N. Therefore, thanks to the transmission lever 36, one is capable of substantially conserving the bulkiness of the drive mechanism relative to the conventional gas spring 16, but reducing the effort needed to open the tail gate 14 by ten times.

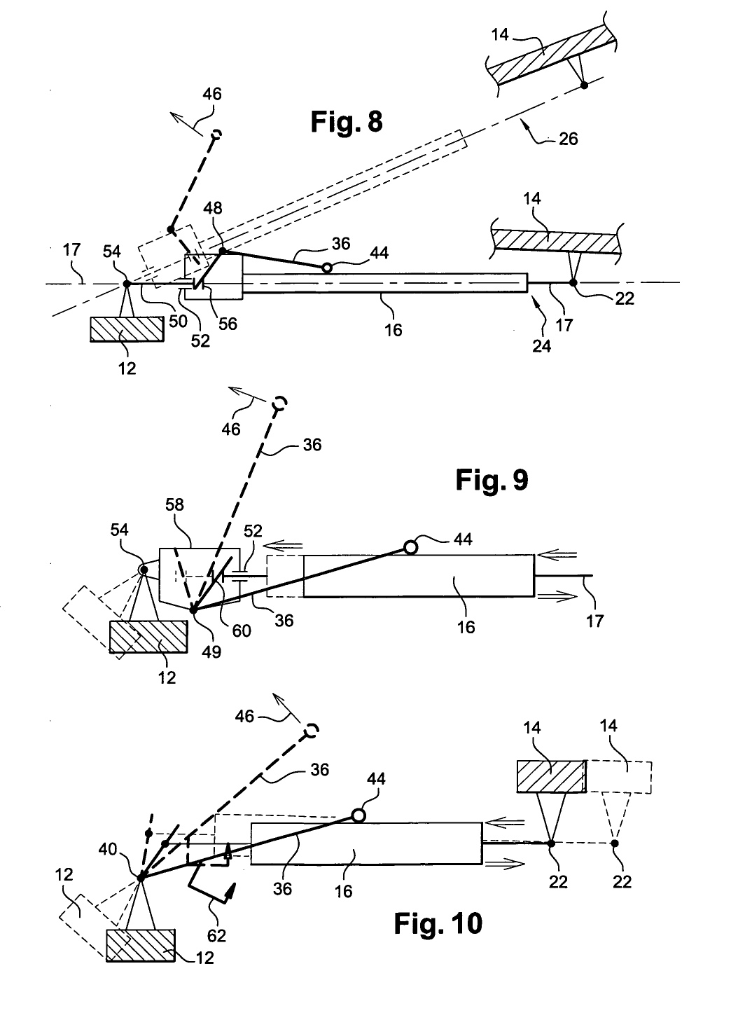

FIGS. 8 and 9 are other variants of the drive mechanism of the tail gate 14. In these figures, the drive mechanism is shown horizontally instead of being shown vertically. The gas spring 16 extends along its line of action 17 and is connected to the tail gate 14 by the hinge 22. In the closed position 24 of the tail gate 14, the gas spring 16 exerts torque on the tail gate 14 relative to the hinge 18, with the torque visible in FIG. 2. In accordance with these figures, the gas spring 16 has a degree of liberty in translation relative to the body 12. The gas spring 16 is connected to the body 12 by way of a component 50 and 58. The gas spring 16 and the component 50 and 58 have relative movement of translation permitting the degree of liberty of the gas spring 16. The relative movement of translation is realized by a sliding link 52 between the gas spring 16 and the component 50 and 58. In addition, the component 50 and 58 is hinged to the body 12 by a hinge 54, also allowing the gas spring 16 to hinge on the body 12. The transmission lever 36 is hinged by a hinge 48 to the ensemble of gas spring 16 and the component 50 and 58. Activating the gas spring 16 causes relative translation of the gas spring 16 relative to the body by the component 50 and 58. This allows activating of the transmission lever 36 about the hinge 48. The transmission lever 36 rocks and actuates the tail gate 14 with a lever arm greater than the lever arm developed by the gas spring 16 activating the tail gate 14 alone. The advantages associated with actuating the tail gate 14 by the transmission lever 36 described in context with FIG. 2 also apply here.

According to FIG. 8, the gas spring 16 is hinged to the body 12 by the component 50 in the form of a connecting rod. The connecting rod extends along the line of action 17. The connecting rod is hinged to the body 12 by the hinge 54 and is connected to the gas spring 16 by the sliding link 52. The transmission lever 36 is hinged to the gas spring 16 by the hinge 48. The connecting rod is also connected to the transmission lever 36. The connecting rod includes a passage 56 through which the transmission lever 36 extends. According to the respective position of the gas spring 16 and of the connecting rod, the transmission lever 36 engages more or less through the passage 56.

When the gas spring 16 is activated, a part of the gas spring 16 (for example the piston) is actuated towards the hinge 54, causing translation of the gas spring 16 relative to the connecting rod. The shifting of the gas spring 16 in the direction of the hinge 54 causes engagement of the transmission lever 36 through the passage 56 of the connecting rod. Since the transmission lever 36 is also hinged to the gas spring 16, the movement of the gas spring 16 activates the transmission lever 36 in rotation about the hinge 48. By its sliding contact 44, the transmission lever 36 actuates the tail gate 14 according to the force 46. This force 46 exerts torque on the tail gate 14 with a lever arm relative to the hinge 18 greater than the lever arm of the torque exerted by the gas spring 16 alone. This allows the tail gate 14 to exit from the closed position 24 and to reach the intermediate position 26. Beyond the intermediate position 26, only the gas spring 16 actuates the tail gate 14.

According to FIG. 9, the gas spring 16 is hinged to the body 12 by the component 58 in the form of a housing. The housing is hinged to the body 12 by the hinge 54 and is connected to the gas spring 16 by the sliding link 52. The transmission lever 36 is hinged to the housing by the hinge 49. This gas spring 16 is also connected to the transmission lever 36. The gas spring 16 includes a passage 60 through which the transmission lever 36 extends. According to the respective position of the gas spring 16 and of the housing, the transmission lever 36 engages more or less through the passage 60.

When the gas spring 16 is activated, a part of the gas spring 16 (for example the piston) is actuated towards the hinge 54, causing translation of the gas spring 16 relative to the housing. The displacement of the gas spring 16 in the direction of the hinge 54 causes engagement of the transmission lever 36 through the passage 60 of the gas spring 16. Since the transmission lever 36 is also hinged to the housing, the movement of the gas spring 16 activates the transmission lever 36 in rotation about the hinge 49. By its sliding contact 44, the transmission lever 36 actuates the tail gate 14 according to the force 46. This force 46 exerts torque on the tail gate 14 with a lever arm relative to the hinge 18 greater than the lever arm of the torque exerted on the gas spring 16 alone. This enables the tail gate 14 to exit from the closed position 24 and to shift into an intermediate position.

FIG. 10 shows another variant of the drive mechanism of the tail gate 14. This is in particular a variant of FIG. 2. In this figure, the drive mechanism is shown horizontally instead of being shown vertically. The body 12 and the gas spring 16 are connected to the hinge 22 on the tail gate 14. The line of action 17 of the gas spring 16 is visible. Also, the transmission lever 36 is illustrated. The transmission lever 36 actuates the tail gate 14 by the sliding contact 44, and the transmission lever 36 itself is actuated by the gas spring 16. The representation of the elements in solid lines corresponds to the closed position 24 of the tail gate 14 and the representation of the elements in dotted lines corresponds to an intermediate position 26 of the tail gate. When the gas spring 16 is activated, the transmission lever 36 is activated by the gas spring 16 and actuates the tail gate 14 by the force 46. The advantages associated with actuating the tail gate 14 by the transmission lever 36 described in connection with FIG. 2 also apply here.

In addition, the transmission lever 36 includes an abutment 62. In the closed position 24 of the tail gate 14, the abutment 62 is not in contact with the gas spring 16. During activation of the transmission lever 36 by the gas spring 16, the abutment 62 comes up against the gas spring 16. This is visible when the tail gate 14 is in the intermediate position (elements shown in dots). The abutment 62 comes up against the gas spring 16, allowing the rotation of the gas spring 16 to be favored relative to the hinge 40 of the transmission lever 36 on the body 12. This also favors the opening of the tail gate 14 until its automatic opening position.

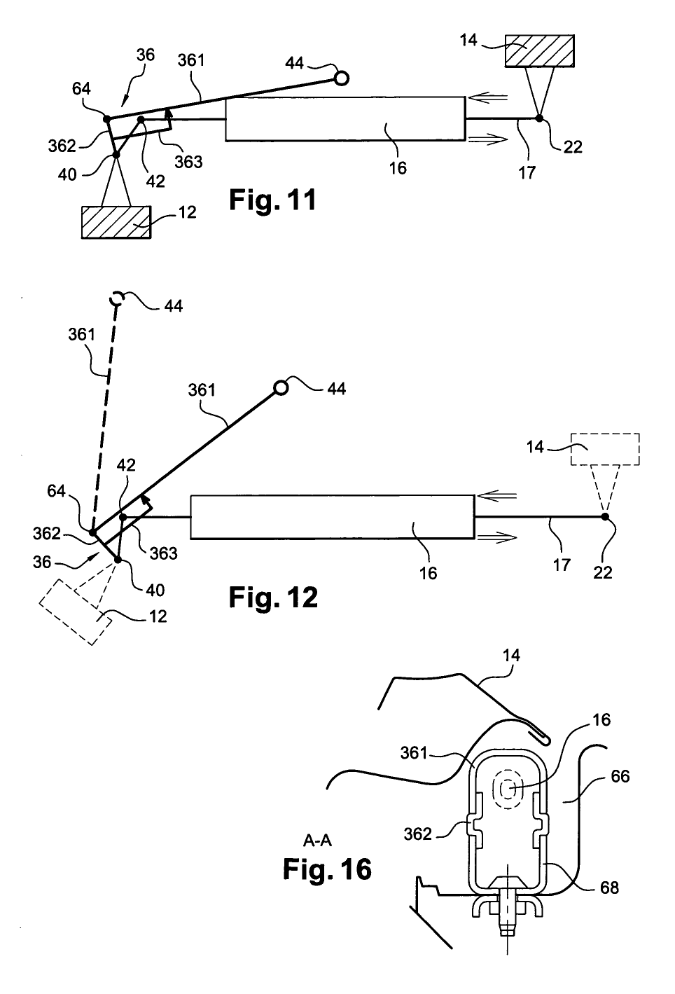

FIGS. 11 and 12 show yet another variant of the drive mechanism of the tail gate 14, in several positions of the tail gate 14 relative to the body 12. This is also a variant of FIG. 2. In these figures, the drive mechanism is shown horizontally instead of being shown vertically. FIGS. 11 and 12 show the body 12, and the gas spring 16 connected to the hinge 22 on the tail gate 14. The line of action 17 of the gas spring 16 is visible. Also, the transmission lever 36 is shown. The transmission lever 36 actuates the tail gate 14 by the sliding contact 44 and the transmission lever 36 is itself actuated by the gas spring 16. The advantages associated with actuating the tail gate 14 by the transmission lever 36 described in connection with FIG. 2 also apply here.

All the same, the transmission lever 36 has a particular form. The transmission lever 36 includes a main lever 361 for actuating the tail gate 14, especially by the sliding contact 44. The transmission lever 36 also includes a second lever 362 hinged to the body 12, especially by the hinge 40. The main lever 361 and the second lever 362 are solid in rotation between a first angular position and a second angular position of the tail gate 14. This is shown in FIG. 12 in solid lines. Further to this, the main lever 361 is adapted to be impelled by the gas spring 16 relative to the second lever 362 beyond the second position. This is shown by the main lever 361 in dotted lines in FIG. 12.

The advantage of such an embodiment is, apart from augmentation of the lever arm such as described in connection with FIG. 2, the compactness of the drive mechanism of the tail gate 14. In fact, such realization of the drive mechanism of the tail gate 14 allows movement of the elements in the same plane, effectively limiting the bulkiness of the mechanism.

FIG. 11 schematically shows the drive mechanism of the tail gate 14 when the tail gate 14 is in the closed position 24. The second lever 362 is hinged to the body 12 by the hinge 40 and to the gas spring 16 via the hinge 42. The main lever 361 is hinged to the second lever 362 by means of a hinge 64. In addition, the transmission lever 36 includes an abutment 363, making the main lever 361 and the second lever 362 integral. As long as the main lever 361 and the second lever 362 are integral, the transmission lever 36 functions as shown in FIG. 2.

FIG. 12 shows the drive mechanism of the tail gate 14 when the tail gate 14 has left the closed position 24. This is shown by the inclination of the body. It is significant that the gas spring 16 and the tail gate 14 are in a different position relative to that is FIG. 11. In FIG. 12, the main lever 361 is shown in two positions in solid lines and in dotted lines. To shift to FIG. 12, the gas spring 16 activates the second lever 362 of the transmission lever 36. The second lever 362 undergoes rotation about the hinge 40. The second lever 362 impels the main lever 361 towards the position shown in solid lines of the main lever 361. Then the tail gate 14 has reached the automatic opening position in which the transmission lever 36 no longer actuates the tail gate 14. Only the gas spring 16 actuates the tail gate 14, and the gas spring 16 continues its rotation in driving the main lever 361 towards the position marked in dotted lines in FIG. 12.

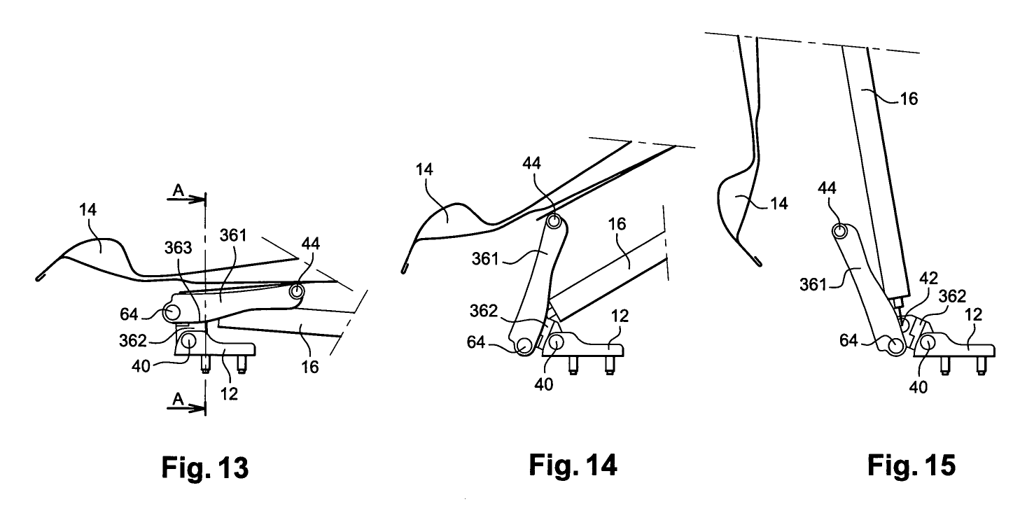

FIGS. 13 to 15 show the diverse positions of the tail gate in FIGS. 11 and 12. In the figures, the mechanism is shown according to an embodiment of main lever 361 and the second lever 362. The main lever 361 is in the form of a rod with a transversal U section. In the closed position of the tail gate, the main lever 361 rests astride the gas spring 16 and the second lever 362. The second lever 362 is a block allowing the main lever 361 and the gas spring 16 to hinge to the body 12 by way of the hinge 40. The main lever 361 is hinged to the second lever 362 by the hinge 64. The abutment 363 is in the form of a shoulder of the second lever 362 coming into contact with the longitudinal edges of the main lever 361. Also, the main lever 361 supports the sliding contact 44, in the form of a small wheel, by which the transmission lever 36 actuates the tail gate 14. The small wheel is in contact with a track of the tail gate 14.

Furthermore, the main lever 361 and the second lever 362 are hinged elastically to one another. Thus, when the tail gate 14 returns to the closed position, the main lever 361 is no longer driven by the gas spring. The main lever 361 is then actuated elastically towards the second lever 362 to resume the position astride the gas spring of FIG. 13. For example, the transmission lever 36 includes a spring elastically actuating the main lever 361 towards the second lever 362.

In FIG. 14, the tail gate 14 is driven in rotation. When the gas spring 16 is activated, the gas spring 16 activates the second lever 362 in rotation relative to the body about the hinge 40. By way of the abutment 363, the second lever 362 drives in rotation the main lever 361, which then actuates the tail gate 14 to open. The main lever 361 and the second lever 362 are rotating together.

In FIG. 15, the second lever 362 reaches the abutment. The rotary movement of the second lever 362 is interrupted. The transmission lever 36 no longer actuates the tail gate 14 and only the gas spring 16 actuates the tail gate 14 to open. The gas spring 16 continues its rotation about the hinge 42 and drives the main lever 361 in rotation relative to the second lever 362 about the hinge 64. The movement of the gas spring 16 is therefore not obstructed by the presence of the main lever 361. This allows the diverse elements of the drive mechanism of the tail gate, namely the gas spring 16 and the transmission lever 36, to have movement in the same plane. In this way, the drive mechanism is not so bulky.

FIG. 16 is a view in section according to the line A-A of FIG. 13. FIG. 16 shows a gutter 66 of the body 12. The transmission lever 36 and the gas spring 16 are in the gutter 66 in the closed position of the tail gate 14. The transmission lever 36 is hinged to the body 12 by way of a base 68. The drive mechanism, such as described in FIGS. 11 to 15, is less bulky, allowing the depth of the gutter 66 towards the interior of the vehicle to be limited. Since the gutter 66 is arranged to the rear of the body 12, at the height of the trunk of the vehicle, the depth of the gutter 66 influences the volume of the trunk. In the present case, in the closed position of the tail gate 14, the transmission lever 36 is compact about the gas spring 16, thus reducing the depth of the gutter 66 and avoiding compromising the volume of the trunk.

In the different embodiments described hereinabove, the gas spring 16 is connected by an intermediate component to the body 12. In particular, the gas spring 16 is hinged by an intermediate component to the body 12. According to FIGS. 2 to 7 and 10 to 15, the intermediate component is the transmission lever 36 itself. According to FIGS. 8 and 9, the intermediate component is, respectively, the connecting rod on the housing. This allows the lever arm of the torque of the tail gate 14 to be increased by the drive mechanism, while limiting the bulk of this mechanism.

In the various embodiments, the lever can take the form of the lever of FIGS. 13 to 15. The lever can also have the form of a connecting rod.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A vehicle comprising:
a body;
a tail gate rotatable relative to the body between a closed position and an open position;
a gas spring for actuating the tail gate, wherein actuation of the tail gate by the gas spring is done with a first lever arm; and
a transmission lever for actuating the tail gate, wherein the transmission lever is adapted to actuate the tail gate between a first angular position and a second angular position, actuation of the tail gate by the transmission lever is done with a second lever arm greater than the first lever arm, the gas spring is adapted to activate the transmission lever, and the transmission lever includes:
a main lever for actuating the tail gate, and
a second lever for hinging to the body,
wherein the main lever and the second lever rotate together between the first angular position and the second angular position of the tail gate, and
wherein the main lever is adapted to be driven in rotation by the gas spring relative to the second lever beyond the second angular position of the tail gate.

2. The vehicle as claimed in claim 1, wherein the second lever arm is greater than the first lever arm when the tail gate is in the closed position.

3. The vehicle as claimed in claim 2, wherein only the gas spring is adapted to actuate the tail gate beyond the second angular position.

4. The vehicle as claimed in claim 1, wherein the first angular position of the tail gate is the closed position.

5. The vehicle as claimed in claim 1, wherein the second angular position of the tail gate is an intermediate position between the closed position and the open position.

6. The vehicle as claimed in claim 1, wherein the transmission lever is in sliding contact with the tail gate.

7. The vehicle as claimed in claim 1, wherein the gas spring has a degree of liberty in translation relative to the body.

8. The vehicle as claimed in claim 1, further including an intermediate component hinging the gas spring to the body.

9. The vehicle as claimed in claim 8, wherein the intermediate component is the transmission lever.

10. The vehicle as claimed in claim 1, wherein the main lever is elastically hinged to and the second lever.

11. The vehicle as claimed in claim 1, wherein the gas spring is hinged to the second lever.

12. The vehicle as claimed in claim 1, wherein the body includes a gutter, and the transmission lever and the gas spring are in the gutter when the tail gate is in the closed position.

13. The vehicle as claimed in claim 1, further including:
a motor for activating the gas spring, and
an electronic control unit associated with the motor, wherein the electronic control unit provides at least one of an anti-pinching function and an anti-collision function during movement of the tail gate.

14. A vehicle comprising:
a body;
a tail gate rotatable relative to the body between a closed position and an open position;
a gas spring for actuating the tail gate, wherein actuation of the tail gate by the gas spring is done with a first lever arm; and
a transmission lever for actuating the tail gate, wherein actuation of the tail gate by the transmission lever is done with a second lever arm greater than the first lever arm, and
wherein the gas spring has a degree of liberty in translation relative to the body, and the gas spring is adapted to activate the transmission lever.

15. The vehicle according to claim 14, wherein the second lever arm is greater than the first lever arm when the tail gate is in the closed position.

16. The vehicle as claimed in claim 14, wherein the transmission lever is adapted to actuate the tail gate between a first angular position and a second angular position, and only the gas spring is adapted to actuate the tail gate beyond the second angular position.

17. The vehicle as claimed in claim 16, wherein the transmission lever includes:
a main lever for actuating the tail gate, and
a second lever for hinging to the body,
wherein the main lever and the second lever rotate together between the first angular position and the second angular position of the tail gate, and
wherein the main lever is adapted to be driven in rotation by the gas spring relative to the second lever beyond the second angular position of the tail gate.

18. The vehicle as claimed in claim 17, wherein the main lever is elastically hinged to the second lever.

19. The vehicle as claimed in claim 18, further including:
a motor for activating the gas spring, and
an electronic control unit associated with the motor, wherein the electronic control unit provides at least one of an anti-pinching function and an anti-collision function during movement of the tail gate.

20. A method for driving a tail gate relative to a vehicle body of a vehicle, the vehicle comprising:
a body,
a tail gate rotatable relative to the body between a closed position and an open position,
a gas spring for actuating the tail gate, wherein actuation of the tail gate by the gas spring is done with a first lever arm,
a transmission lever for actuating the tail gate, wherein the transmission lever is adapted to actuate the tail gate between a first angular position and a second angular position, actuation of the tail gate by the transmission lever is done with a second lever arm greater than the first lever arm, and the transmission lever includes:
a main lever for actuating the tail gate, and
a second lever for hinging to the body,
wherein the main lever and the second lever rotate together between the first angular position and the second angular position of the tail gate, and
wherein the main lever is adapted to be driven in rotation by the gas spring relative to the second lever beyond the second angular position of the tail gate, the method comprising the steps of:
actuating the tail gate by the gas spring and by the transmission lever between two angular positions of the tail gate, and
actuating the tail gate by only the gas spring between two other angular positions of the tail gate.
